(19) United States
(12) Patent Application Publication
(10) Pub. No.: US 2022/0284512 A1
(43) Pub. Date: Sep. 8, 2022

(54) SYSTEM AND METHOD FOR DETERMINING A DISTRIBUTED NET INCOME (DNI) OF A TRUST

(71) Applicant: Jack R. Brister, Long Island City, NY (US)

(72) Inventor: Jack R. Brister, Long Island City, NY (US)

(21) Appl. No.: 17/654,041

(22) Filed: Mar. 8, 2022

Related U.S. Application Data
(60) Provisional application No. 63/200,459, filed on Mar. 8, 2021.

(51) Int. Cl. G06Q 40/06; G06Q 40/00

(52) U.S. Cl. CPC G06Q 40/06; G06Q 40/123

(57) ABSTRACT

A method for determining a distributed net income (DNI) of a trust. The method comprises obtaining one or more information, wherein the one or more information includes at least a general trust information, a beneficiary information, and a financial data information related to an income from trust's assets. Further, the method comprises determining a net income of the trust's assets, a net realized rate of return, and a pre-defined year taxable income from the financial data information. Furthermore, the method comprises determining the DNI of the trust, using the net income of the trust's assets.

### CROSS-REFERENCE TO RELATED APPLICATIONS AND PUBLICATIONS

This application claims the priority benefit of provisional patent application Ser. No. 63/200,459, filed Mar. 8, 2021 by the present inventor, which is incorporated herein by reference in its entirety. Further, this application, in accordance with 37 CFR 1.57(d), incorporates by reference in its entirety Brister, J. R. (2019, Apr. 16). Estate Planning with Foreign Trusts/Fundamentals of Foreign Trust Tax on Distributions to U.S. Beneficiaries. [Conference Presentation]. Strafford Publications CPE and CLE Webinar, United States.

### FIELD OF THE DISCLOSURE

The invention relates to a method and system to determine a US beneficiary's portion of taxable net income (i.e. Distributable Net Income (DNI)) and or distributive share of trust principal and/or accumulated income from a foreign trust and provide each beneficiary with a statement itemizing their proportionate share of various types of net taxable income such as interest, dividend, and capital gain, and/or distributive share of principle and/or accumulated income.

### BACKGROUND OF THE DISCLOSURE

The subject matter discussed in this background section should not be assumed to be prior art merely as a result of its mention herein. Similarly, any problems mentioned in this background section or associated with the subject matter of this background section should not be assumed to have been previously recognized in the prior art. The subject matter as disclosed in this background section merely represents different approaches related to methods for tax computation, wherein such methods themselves may also correspond to implementations of the claimed technology and invention.

Taxation is a compulsory financial charge imposed, on a taxpayer, by a governmental organization in order to fund government spending and various public expenditures. Taxpayers may be individuals, business entities, estates, trusts, or other forms of organization. At present, tax preparation is based on a tax form model for collecting information about a taxpayer's income, deductions, and tax credits. Information from the taxpayer is collected in a way that directly follows the format and sequence of government tax forms. The government tax forms segregate the tax information into tax-oriented categories of taxpayer status, income, wages, deductions, etc. Taxpayers are generally not aware of the financial terms and find it difficult to provide the information requested. For that reason, the process of going through a tax form line by line and entering data can be both arduous and counterintuitive. A system and process for gathering and interpreting suggested correct required information reduces complexity associated with the tax filing by providing an intuitive machine-driven guide for completion of taxpayer forms.

Tax preparation is a time-consuming and laborious process, with an estimate that individuals and businesses spend around 7 billion hours per year complying with the filing requirements promulgated by the Internal Revenue Service in the United States. Tax preparation software has been commercially available to assist taxpayers in preparing their tax returns. Tax preparation software is typically run on a computing device such as a computer, laptop, tablet, a mobile computing device such as a Smartphone, or remotely on another computer and accessed via a network. Traditionally, a user has walked through a set of rigidly defined user interface interview screens that selectively ask questions that are relevant to a particular tax topic or data field needed to calculate a taxpayer's tax liability and/or taxpayer status.

Further, in the US, tax law requires a person to disclose the distribution received from a foreign trust, regardless of the amount, while filing the tax return. When a trust makes a distribution, it deducts the income distributed on its tax return and issues the beneficiary with a tax form. This taxation of the income and distributions from a foreign trust depends on the type of foreign trust and the status of the trust's beneficiaries at the time of distribution. International Wealth Tax Practitioners generally provide complex consultancy in cross border tax issues in order to protect offshore investment portfolios. Further, the International Wealth Tax Practitioners provide tax-efficient strategies, much of which is derived from a knowledge of law in light of past strategies utilized, for ultra-wealthy non-U.S. families with a member(s) of the family being treated as US taxpayers and business entities invested or desiring to invest in a U.S. marketplace. Further, the International Wealth Tax Practitioners offer Trust Income Distribution statements through calculation reports with the use of excel spreadsheets that are managed manually on a customer by customer basis. Accordingly, there is a need for a new platform that allows a customer to input all available information and generate Trust Income Distribution statements for multiple trusts as well as provide the facility to update the distribution annually and download these reports for each client for the tax returns. Furthermore, there is a need for a platform that provides strategies derived from a learned knowledge base to suggest to taxpayers and practitioners those strategies that have been successfully executed for situations the same/similar to that of the taxpayer.

Prior art, for various aspects contained therewithin, relevant to this disclosure includes U.S. Pat. Pub. No. 20020111888 to Stanley, U.S. Pat. Pub. No. US10140666 to Wang, U.S. Pat. No. 20070033117 to Murray. In each of these prior art references, automated tax preparation is provided. However, the prior art fails to address the problem of determining the distributed net income of a trust or the corresponding beneficiaries.

In particular, the Stanley reference '888 discloses a universal device and method for automated tax return preparation using a relationship-based interview process coupled with universal data import. Information is collected through a process called the interview, during which a taxpayer is asked various questions about her background and relationships with financial institutions. The taxpayer provides to the tax planning software a list of financial institutions with which the taxpayer has a relationship, and the tax software retrieves tax data directly from the financial institutions. The combination of the interview, universal data import, and existing stored data enables an automated tax return system to prepare tax returns in advance with minimal user assistance. However, unlike the subject matter of the disclosed invention, Stanley does not discuss or suggest determining the distributed net income of a trust or the corresponding beneficiaries. Furthermore, Stanley does not disclose a process for determining tax liability or status which portends to a desired purpose or outcome for the taxpayer, e.g., paying the lawful minimum amount of tax due based on the experiences of the same/similar situation for other taxpayers.

Reference '666 to Wang discloses targeted gathering of tax data for use with tax preparation software including a computing device presenting to the user a plurality of interview questions or statements. The computing device creates a user profile based on the responses to the interview questions or statements. The computing device identifies highly relevant tax topics based on user profile and executes a user interface manager to automatically generate interview questions or statements on said highly relevant tax topics. The user then confirms whether other tax topics apply to the user. The computing device executes a tax calculation engine of the tax preparation software configured to compute a tax liability or refund amount. However, unlike the subject matter of the disclosed invention, Wang does not discuss or suggest determining the distributed net income of a trust or the corresponding beneficiaries. Furthermore, Wang does not disclose a process for determining tax liability or status which portends to a desired purpose or outcome for the taxpayer, e.g., paying the lawful minimum amount of tax due based on the experiences of the same/similar situation for other taxpayers.

Reference '117 to Murray discloses a method of acquiring tax data to be used in preparing a tax return for a current tax-reporting period includes providing a graphical user interface displayable on a display device. In connection with at least one tax-data item associated with a prior tax-reporting period, the interface is operable to present to a user at least one displayable page soliciting user selection of at least one item for updating and at least one updated tax-data item is received from the user. However, unlike the subject matter of the disclosed invention, Murray does not discuss or suggest determining the distributed net income of a trust or the corresponding beneficiaries. Furthermore, Murray does not disclose a process for determining tax liability or status which portends to a desired purpose or outcome for the taxpayer, e.g., paying the lawful minimum amount of tax due based on the experiences of the same/similar situation for other taxpayers.

Given the deficiencies of the prior art, the need remains for an effective method for determining the distributed net income of a trust or the corresponding beneficiaries. In addition, there is a need for a platform that provides strategies derived from a learned knowledge base to suggest to taxpayers and practitioners those strategies that have been successfully executed for situations the same/similar to that of the taxpayer.

### SUMMARY OF THE DISCLOSURE

According to embodiments illustrated herein, there is shown and described a novel and improved method for determining a distributed net income (DNI) of a foreign trust. The method may comprise obtaining one or more information, wherein the one or more information includes at least a general trust information, a beneficiary information, and a financial data information related to an income from trust's assets, determining a net income of the trusts, a net realized rate of return, and a pre-defined year taxable income based on the obtained one or more information, and determining the DNI of the trust, based on the net income of the trust's assets. Further, the general trust information is the information associated with trustees and beneficiaries associated with the trust, the beneficiary information is the information associated with the beneficiaries associated with the trust, and financial data information is the information associated with income and expenses of the trustees and beneficiaries of the trust. Further, the method may comprise determining a DNI allocable to one or more beneficiaries, displaying the DNI allocable to the one or more beneficiaries, and alerting, the one or more beneficiaries, with the DNI allocable the one or more beneficiaries. In an aspect, the method described and/or processes utilized determines a US beneficiary's portion of taxable net income (aka distributable net income) and or distributive share of trust principal and or accumulated income from a foreign trust and provide each beneficiary with a statement itemizing their proportionate share of various types of net taxable income such as interest, dividend, and capital gain, and or distributive share of principle and or accumulated income.

In one example embodiment, the method comprises determining the trust as a US-trust or a foreign trust, based on the general trust information. In another example embodiment, the method comprises classifying the foreign trust into a foreign grantor trust or a foreign non-grantor trust. Further, the method comprises computing a 65-day distribution rule to determine total amount of distributions made to the one or more beneficiaries of the trust. The 65-day distribution rule is computed based on the determined DNI and trustee distribution patterns.

In another example embodiment, the method comprises allocating the DNI to each of the one or more beneficiaries on a net basis or the amount of return of principal to be reported by each beneficiary. In another example embodiment, the method comprises determining tax return filing requirements for the US beneficiaries and trustee for the trust. Further, the method comprises sending an alert and a list of filing requirements to the user.

In a further exemplary embodiment, the method comprises determining life of the trust-based at least on investments, trustee distribution pattern of prior years' distributions, and net realized rate of return. In another exemplary embodiment, the one or more information is obtained automatically, using third party services. Further, the third-party services include at least one of government tax application programming interfaces (APIs), Xero, and clear books.

In one exemplary embodiment, the method comprises estimating DNI based on historical DNI calculation data. In an exemplary aspect of this embodiment, historical data, including at least a general trust information, a beneficiary information and a financial data information and/or other tax calculation parameters associated with learned useful strategies, may be provided to estimate DNI calculation.

In yet another exemplary embodiment, a novel and an improved system for determining a distributed net income (DNI) of a foreign trust is disclosed. The system may comprise means for obtaining one or more information, wherein the one or more information includes at least a general trust information, a beneficiary information, and a financial data information related to the income from trust assets, means for determining a net income of the trust's assets, a net realized rate of return, and a pre-defined year taxable income based on the obtained one or more information, and means for determining a DNI of the trust, based on the net income of the trust's assets. Further, the general trust information is the information associated with trustees and beneficiaries associated with the trust, the beneficiary information is the information associated with the beneficiaries associated with the trust, and financial data information is the information associated with income and expenses of the trustees and beneficiaries of the trust.

In one example embodiment, the system comprises means for determining a DNI allocable to one or more beneficiaries, means for displaying the DNI allocable to the one or more beneficiaries, and means for alerting, the one or more beneficiaries, with the DNI allocable to the one or more beneficiaries. Further, the system comprises means for determining the trust as a US-trust or a foreign trust, based on the general trust information and tax laws of the relevant and appropriate taxing jurisdiction.

In one example embodiment, the system comprises means for classifying the foreign trust into a foreign grantor trust or a foreign non-grantor trust and means for allocating the DNI to each of the one or more beneficiaries on a net basis or the amount of return of principal to be reported by each beneficiary.

In another exemplary embodiment, the system comprises means for determining tax return filing requirements for the US beneficiaries and the trustee for the trust and means for determining life of the trust-based at least on investments, trustee distribution pattern including distribution patterns of prior years' distributions, and net realized rate of return.

Other features and aspects of this disclosure will be apparent from the following description and the accompanying drawings.

### BRIEF DESCRIPTION OF THE DRAWINGS

While the specification concludes with claims particularly pointing out and distinctly claiming particular embodiments of the present disclosure, various embodiments of the present disclosure can be more readily understood and appreciated from the following descriptions of various embodiments of the present disclosure when read in conjunction with the accompanying drawings, in which:

FIG. 1 illustrates a system for taxable income computation, according to an embodiment of the present disclosure;

FIG. 2 illustrates a flowchart for taxable income computation, according to another embodiment of the present disclosure;

FIG. 3A illustrates a web application showing a login page, according to an embodiment of the present disclosure;

FIG. 3B illustrates the web application showing a dashboard, according to an embodiment of the present disclosure;

FIG. 3C illustrates the web application showing one or more trusts in a window, according to an embodiment of the present disclosure;

FIG. 3D illustrates the web application showing a view trust window, according to an embodiment of the present disclosure;

FIG. 3E illustrates the web application showing an edit trust window, according to an embodiment of the present disclosure;

FIG. 3F illustrates the web application showing a DNI calculation list window, according to an embodiment of the present disclosure;

FIG. 3G illustrates the web application showing a step of new DNI calculations creation window, according to an embodiment of the present disclosure;

FIG. 3H illustrates the web application showing a step of final investments copy in the new DNI calculations creation window, according to an embodiment of the present disclosure;

FIG. 3I illustrates the web application showing another step of a new DNI calculations creation window, according to an embodiment of the present disclosure;

FIG. 3J illustrates the web application showing a beneficiary allocation window, according to an embodiment of the present disclosure;

FIG. 3K illustrates the web application showing a step of displaying a report, according to an embodiment of the present disclosure;

FIG. 3L illustrates a web application showing a step of displaying another report, according to an embodiment of the present disclosure;

FIG. 3M illustrates the web application showing a window for displaying account settings, according to an embodiment of the present disclosure; and

FIG. 3N illustrates the web application showing a window for displaying company settings, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

Some embodiments of this disclosure, illustrating all its features, will now be discussed in detail. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context dictates otherwise. Although any number of systems and methods similar or equivalent to those described herein can be used in the practice or testing of embodiments of the present disclosure, the preferred systems, and methods are now described.

Embodiments of the present disclosure will be described more fully hereinafter with reference to the accompanying drawings in which like numerals represent like elements throughout the several figures, and in which example embodiments are shown. Embodiments of the present disclosure may, however, be embodied in alternative forms and should not be construed as being limited to the embodiments set forth herein. The examples set forth herein are non-limiting examples and are merely examples among other possible examples.

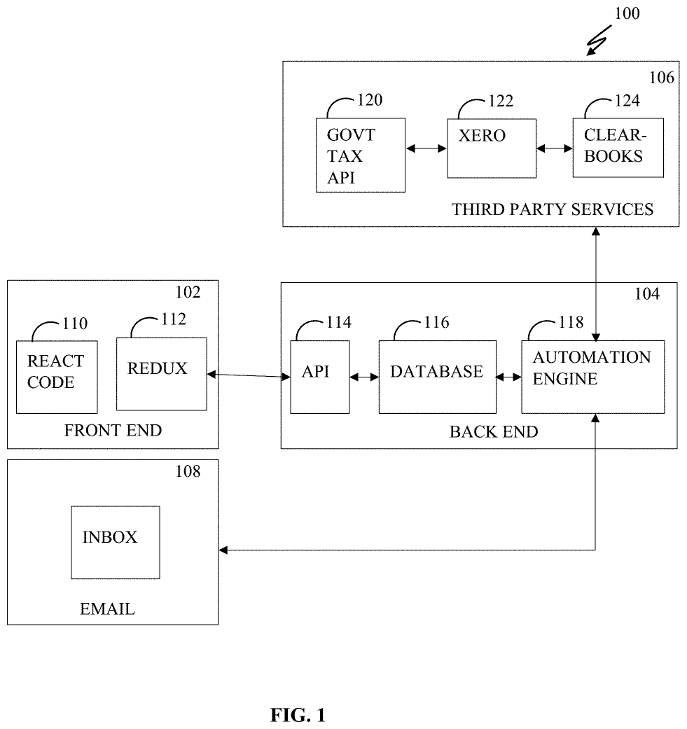

FIG. 1 illustrates a system 100 for determining a distributed net income (DNI) of a trust in accordance with an embodiment of the present disclosure. The system 100 may facilitate determining a US beneficiary's portion of DNI and/or distributive share of trust principal and or accumulated income (UNI) from a foreign trust and provide each beneficiary with a statement itemizing their proportionate share of various types of net taxable income such as interest, dividend, and capital gain, and/or distributive share of principle and/or accumulated income. The UNI may be defined as the excess amount of income, apart from the total distributions for the year exceeding the DNI. The system 100 comprises a front end block 102, a back end block 104, a third party services block 106, and an email block 108.

The front end block 102 may comprise a code block 110 and a Redux block 112. In one embodiment, the code block 110 may be React. It should be noted that React is an open-source framework for writing front end codes, which facilitates in creating components and routes to deliver an interactive web application. Further, the front end block 102 may be operational based on the code written in the code block 110. In one example embodiment, the code block 110 may facilitate the user with a web application. In one embodiment, the Redux block 112 may be a state management tool. It should be noted that the Redux block 112 is a predictable state container designed for writing JavaScript apps that behave consistently across client, server, and native environments and are easy to test. Further, the Redux block 112 may be communicatively connected to receive or send data to an application programming interface (API) 114 of the back end block 104.

The back end block 104 may comprise the API 114, a database 116, and an automation engine 118. In one embodiment, the API 114 may facilitate communication between the back end block 104 and the front end block 102. In one embodiment, the database 116 may store user records, trust data, and information necessary for the DNI computation. In a further embodimnent, the database 116 may store historical tax filing records associated with one or more user records, trust data, and information necessary for DNI computation. It should be noted that the database 116 may contain normalized accounting information from various third-party services 10, that the automation engine 118 may link with. Further, the back end block 104 may comprise server-side logic and data to be delivered to the third-party service platform.

It should be noted that the automation engine 118 may use machine learning or Artificial Intelligence (AI) technology for performing processing at the back end block 104. Further, the automation engine 118 may facilitate the user in determining DNI for a particular trust of one or more beneficiaries, based on the data available from the third party services block 106. In one embodiment, the automation engine 118 may serve the front end block 102, with information processed at the back end block 104. In an exemplary aspect, machine learning or AI may consider historical DNI computations for predicting and/or suggesting future DNI computations to the users. The AI technology of the system for taxable income computation collects experiential knowledge data from various users, said users using their cognitive ability, to tackle various scenarios of DNI calculations including out-of-the-norm situations learned and executed to success in tax preparation (e.g., returns red-flagged forms by IRS due to errors, inconsistencies, etc.). In a further aspect:
(i). the AI technology curates and prepares domain-specific data (e.g., trust data, DNI worksheet information, tax and regulatory information, beneficiary data, etc.) which is fed into learning algorithms which are iteratively trained and continuously improved to predict and/or suggest future DNI computations, strategies and the like to users;
(ii). the machine learning model may deduce from such data what features and patterns utilized in DNI calculations are important to predict and/or suggest future DNI computations, strategies and the like, without human intervention in explicitly encoding this knowledge; and, without limitation of the scope of the AI technology
(iii). the AI/machine learning module collects, cleans, manipulates, labels, analyzes, and visualizes data that feeds neural networks; the machine learning models extrapolate important features and patterns in the data and combinations of data—i.e., scenarios.

The system 100 after making certain determinations by way of machine learning and mathematical algorithms may be able to diagnose and highlight tax filing issues to alert the user and provide some general solutions and financial and tax planning opportunities. It is envisioned that these planning opportunities, heretofore requiring human cognitive analysis because of the personal nature of financial and tax matters, may be acted on by AI technology including those that simulate human thought, human cognition, context, and intent (i.e., cognitive computing applications). In this case, the AI technology may be built on cognitive models that mimic human thought processes, including machine learning, deep learning, neural networks, NLP and sentiment analysis.

The mathematical computations and machine learning capabilities of system 100 will be drawn from datasets, including a general trust information database, a current and prior year financial information database, and a general information beneficiary database. In an aspect, the general trust and beneficiary information may be extracted directly from the trustee's internal fiduciary software by way of an API. Financial data (income and expenses) information may be directly extracted from yearly statements provided in various formats including word processing formats, pdf format by the custodian of the financial assets as well as some data be directly accessible from the system of the custodian of the assets.

Using computational algorithms, the system 100 may use income and expense data to automatically determine the trust's net taxable income on a per income item basis and allocate each type of income on a net basis or the amount of return of principal to be reported by each US beneficiary. Furthermore, the system 100 may use computational algorithms to automatically determine the net realized rate of return (after additional taxes and penalties for accumulated income) while also using the AI technology to determine the life of a trust fund based on the trustee's financial patterns of prior years' distributions. For example, computational algorithms may be used to determine from the financial database(s) the current year taxable income and use AI technology to determine and alert the user if the trustee's current year pattern of distributions warrants a 65-day election and distribution to avoid future penalties for accumulated income. Even further, data points within the general trust information database the application may be used with a combination of algorithms and AI machine learning technology to make a determination of whether the trust is a US or foreign trust, and if a foreign trust, whether it is a foreign grantor or foreign non-grantor trust. In an aspect, the system 100 would alert a user and report the results of its analysis along with the factors that determined the result. In this case, a user may review the factors and decide whether the system 100 determination is correct or if further analysis is warranted. Additionally, the system 100 would determine the US information tax return filing requirements and provide the user with an alert and list of the filing requirements.

In one example embodiment, the automation engine 118 may include a processor (not shown) that includes suitable logic, circuitry, and/or interfaces that are operable to execute instructions stored in the memory to perform various functions. The processor may execute an algorithm stored in the memory for the system 100 for determining the DNI of the trust. The processor may also be configured to decode and execute any instructions received from one or more other electronic devices or server(s). The processor may include one or more general-purpose processors (e.g., INTEL® or Advanced Micro Devices® (AMD) microprocessors) and/or one or more special-purpose processors (e.g., digital signal processors or Xilinx® System On Chip (SOC) Field Programmable Gate Array (FPGA) processor). The processor may be further configured to execute one or more computer-readable program instructions, such as program instructions to carry out any of the functions described in the description. Further, the processor may make decisions or determinations, generate frames, packets or messages for transmission, decode received frames or messages for further processing, and other tasks or functions described herein. The processor, which may be a baseband processor, for example, may generate messages, packets, frames or other signals for transmission via wireless transceivers. It should be noted that the processor may control the transmission of signals or messages over a wireless network, and may control the reception of signals or messages, etc., via a wireless network (e.g., after being down-converted by a wireless transceiver, for example). The processor may be (or may include), for example, hardware, programmable logic, a programmable processor that executes software or firmware, and/or any combination of these. Further, using other terminology, the processor along with the transceiver may be considered as a wireless transmitter/receiver system, for example.

In one example embodiment, the trust may be defined as a fiduciary relationship in which one party, known as a trustor, gives another party, the trustee, the right to hold title to property or assets for the benefit of a third party i.e. beneficiaries. Further, the trust is an arrangement created either by a will or by an inter vivos declaration whereby trustees may take title to the property for purpose of protecting or conserving the arrangement for the beneficiaries under the ordinary rules applied in chancery or probate courts. Typically, the beneficiaries of such trusts do no more than accept the benefits thereof and may not be the voluntary planners or creators of the trust arrangement. However, the beneficiaries of such trusts may be the persons who created the trust arrangement. Further, the trust arrangement may only be recognized as the trust under the Internal Revenue Code (IRC) if the trust arrangement was created to protect or conserve the trust property for beneficiaries, who stand in the same relation to the trust as the trust arrangement would in case the trust had been created by others for the trust arrangement. Consequently, the trust arrangement may only be treated as the trust under the IRC if it is possible to be shown that the purpose of the trust arrangement is to vest in the trustee's responsibility for protection and conservation of property for beneficiaries who cannot share in the discharge of the responsibility and, therefore, are not associates in a joint enterprise for the conduct of business for profit.

In one example embodiment, the method may use AI for automatic estimation of future DNI calculation fields based on previous or historical DNI calculation data. Hereinafter, the DNI may alternatively be referred to as net taxable income of the trust. It should be noted that future DNI may be computed in addition to the data available from the third party services block 106. In one example embodiment, the AI technology may use records of the DNI calculations across previous years. Further, the records may facilitate correlations between the past DNI calculation parameter like DNI percentage. Based on the identified correlations, AI may be trained to predict with a particular confidence interval. It should be noted that the predictions may be provided to the user with a disclaimer regarding the final decision that shall be made at the user's risk.

In one example embodiment, the system 100 may facilitate the user with an option of insurance related to the financial decisions, enabling the user to connect to third party insurance platforms. Further, the use of AI may facilitate the user to decide on the distribution amount, before the final DNI calculation is made at the end of the year. Additionally, the historical DNI calculation data may also be used to determine the estimated life of a trust fund (i.e., the number of years the trust fund will last) or a rate of return needed for the trust assets to last a certain number of years. Further, the historical DNI calculation data may also be used determine past average rate of return and use the pattern of distributions (i.e., financial requirements of the beneficiaries' trust fund) to estimate the life of the trust fund (similar to that of an annuity). The life of a trust may be based at least on an average rate of return, the trustee distribution pattern of prior years' distributions, and the current value of the trust's assets. Further, the life of a trust may be determined by an excel function defined as:

Life of trust=NPER (average rate of return, pattern of distributions, current value of the trust assets)

Further, the average rate of return may be presented in percentage and may be determined as a ratio of the average of DNI for a period of years to the average value of the trust assets for the same period of years. Alternatively, the historical DNI calculation data may also be used to determine the estimated realized rate of return required for the trust fund (annuity) to last X number years.

Further, the automation engine 118 may be communicatively coupled to the third party services block 106 that may comprise at least one third party service platforms, but not limiting to, a government tax API 120, Xero 122, and Clear Books API 124. It should be noted that the third party services block 106 may be external systems that may be integrated with system 100 to automate various processes of the third-party service platforms. It should be noted that the processes may include data collection and aggregation. In one embodiment, Xero 122 may be used for collecting accounting information from trusts or asset accounts that use this platform. Further, the Clearbooks API is another platform similar to Xero 122, for collecting accounting information from trusts or asset accounts. In one example embodiment, a tax rate API may be used to automatically update tax calculations. In another example embodiment, the system 100 may use open exchange rates for getting live exchange rate data, or data from a snapshot in time. It should be noted that the open exchange rates may facilitate in automatically calculating the value of foreign assets at a point in time for the determining of taxable income. In one example embodiment, the third-party services block 106 may be coupled to the back end block 104. It should be noted that the third party services block 106 may facilitate the back end block 104 with information related to the third-party platforms.

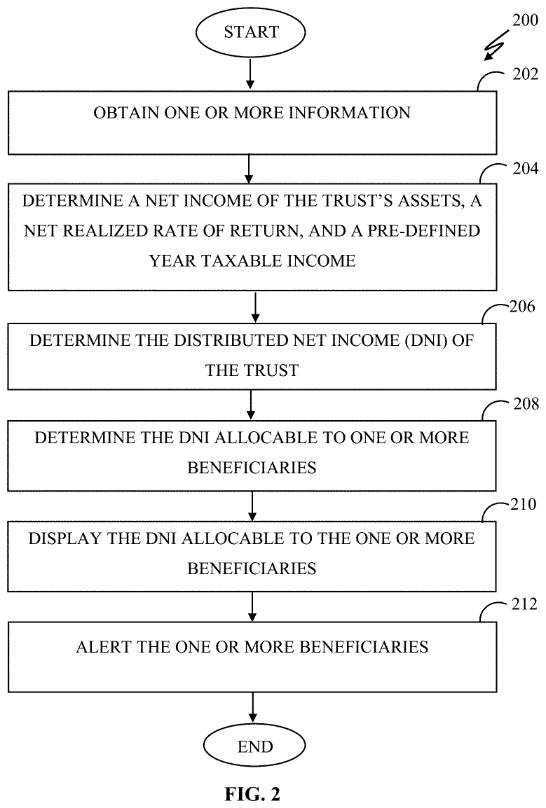

Further, the automation engine 118 may also be communicatively coupled to the email block 108 and may facilitate the user with notifications, via the email block 108. It should be noted that the email block 108 may receive notification from the automation engine 118. In one example embodiment, the back end block 104 may send recommendations to the user, via the email block 108. In one example embodiment, the email block 108 may receive a notification regarding an upcoming DNI calculation. In one example embodiment, the system 100 may diagnose and highlight the issues related to tax computation to the user. In another example embodiment, the system 100 may suggest financial solutions and tax planning opportunities to the user. FIG. 1 is explained in conjunction with FIG. 2.

FIG. 2 may illustrate a flowchart 200 for taxable income computation in accordance with an embodiment of the present disclosure. It should be noted that the flowchart may correspond to a method for determining the DNI for the trust. Hereinafter, the foreign trust may alternatively be referred to as a trust. The trust may be associated with one or more beneficiaries. At first, the method may comprise obtaining one or more information, at step 202. In one embodiment, the one or more information may be obtained automatically, using third party services block 106. Further, the one or more information may include at least a general trust information, a beneficiary information, and a financial data information related to an income from trust's assets. In one embodiment, the financial data used in computing the DNI may be related to the income generated by trust assets. In one case, the one or more information may be qualified dividends from trust's investments in US dividend producing assets/investments or dividends from foreign corporations established in a jurisdiction with a comprehensive income tax treaty with the US. In another case, the one or more information may be non-qualified dividends such as foreign corporation dividends where no US treaty exists. It should be noted that the general trust information may be received from a general trust database.

Further, the general trust information may be defined as information (like name, account information, nationality, sources of income, and investments) related to all the trustors, trustees and the beneficiaries corresponding to the trust. Further, the beneficiary information may be received from a general information beneficiary database. In addition, the general trust information and the beneficiary information may be extracted from a trustee's internal fiduciary software. It should be noted that the general trust information and the beneficiary information may be extracted via the API 114.

Further, the beneficiary information may be defined as information such as, but not limited to, name, identification number, account information, nationality, present address, primary address, tax residence, sources of income, and investments related to all the beneficiaries corresponding to a particular trust. Furthermore, the financial data information may be received from a pre-defined and prior year financial information database. It should be noted that the financial data information may be extracted from a yearly statement of financial assets of a custodian. Further, financial data information may be defined as information such as, but not limited to, sources of income, investments, expenditures related to all the users corresponding to a particular trust. In addition, the financial data information may be extracted from a system of a custodian of assets. Further, the method may comprise determining a net income of the trust's assets, a net realized rate of return, and a pre-defined year taxable income from the financial data information, at step 204. It should be noted that the DNI of the trust may be determined per income basis. Further, the pre-defined year may be set by the user. Additionally, the net realized rate of return is determined in terms of dollars. Further, the trust's investment advisor and the trustee may use the realized rate of return to determine the life of the trust fund based on the financial requirements of the beneficiaries. Based on the determined net income of the trust's assets, net realized rate of return, and the pre-defined year taxable income, the method may comprise determining a distributed net income (DNI) of the trust, at step 206. It should be noted that the DNI may include proportionate share from each category such as, but not limited to, the net interest income, net qualified dividend income, net non-qualified dividend income, other income (except capital gain), and net capital gain income. Further, a dissection or itemization of net trust taxable income may be determined based on the net interest income, net qualified dividend income, net non-qualified dividend income, other income (except capital gain), and net capital gain income equals each category's proportionate share of the total gross trust taxable income.

Based on the determined DNI of the trust, the method may comprise determining a DNI allocable to one or more beneficiaries, at step 208. It should be noted that the determination of the DNI allocable to the one or more beneficiaries may be based on each net category of income allocated to each beneficiary based on the proportionate share of the total amount of distributions. In one example embodiment, the method may also comprise determining beneficiary's share of accumulated income (UNI) and beneficiary share of trust principle such that, if UNI exists, then, the UI may be allocated until exhausted and upon exhaustion (or there is no UNI), distributions in excess of DNI may be treated as distributions of trust principal and may be allocated in proportion of the beneficiary's distributions received to the total amount of distributions to the beneficiaries for the year. Further, the method may comprise displaying the DNI allocable to the one or more beneficiaries may, at step 210. It should be noted that the computed DNI may be displayed via the front end block 102. Further, the back end block 104 may provide alerts or notify the beneficiaries with the DNI allocable to the one or more beneficiaries, at step 212. In one example embodiment, the alerts may be related to future DNI related to the user. Further, the alerts may be related to a subscription of the web application being used by the user.

Further, a beneficiary share of the DNI may be referred as each net category of income is allocated to each beneficiary based on their proportionate share of the total amount of distributions, including 65-day distributions for the year. In one embodiment, a beneficiary share of the UNI may be referred as allocated to each beneficiary based on their proportionate share of the total amount of distributions for the year. In another embodiment, a beneficiary share of the trust principle may be determined by following the steps of allocating the UNI first until exhausted. Upon exhaustion of the UNI or if there is no UNI then distributions in excess of DNI will be treated as distributions of trust principal and allocated in proportion of a beneficiary's distributions received to the total amount of distributions to beneficiaries for the year

In one example embodiment, the automation engine 118 may notify the one or more beneficiaries via the email block 108, by sending an email. Further, the automation engine 118 may send an alert and a list of filing requirements to the user.

In one example embodiment, the method may comprise determining that the trust is a US trust or a foreign trust, based on a general trust information database. Without departing from the scope of or further limiting the present invention, the foreign trust may be determined as a foreign grantor trust or a foreign non-grantor trust.

In one example, embodiment, the net taxable income of the trust may be based on a 65-day distribution rule. Further, the 65-day distribution rule may be an element of the total amount of distributions made to the one or more beneficiaries in a given tax year. In addition, distributed net income may be allocated to each of the one or more beneficiaries on a net basis. The distributed net income may be allocated to each beneficiary depending upon the amount of return on the principal amount allocated to the beneficiary. In one example embodiment, the method may comprise determining tax return filing requirements for a particular country, like the US. In one embodiment, there may be other potential international information returns depending on various factors such as patterns of beneficiary distributions, the trust being discretionary or non-discretionary, assets within the trust's ownership of holding companies in which the assets of the trust are held. In an exemplary embodiment, the US tax law (IRC 958(a) and (b), IRC 1297(b)) may state if a person is a settlor or a beneficiary of the trust based on attributed ownership of some of the trust's holding companies which may require additional tax filings such as Form 5471, Form 8621 and both have very specific tax rules separate and distinct from the foreign trust filing rules.

In one embodiment, the method may also comprise determining life of the trust-based at least on investments, trustee distribution pattern of prior years' distributions, and net realized rate of return.

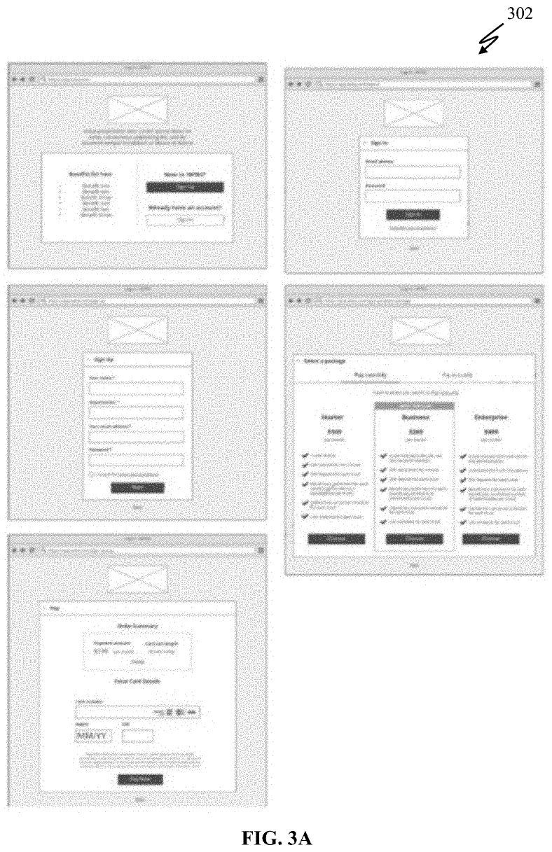

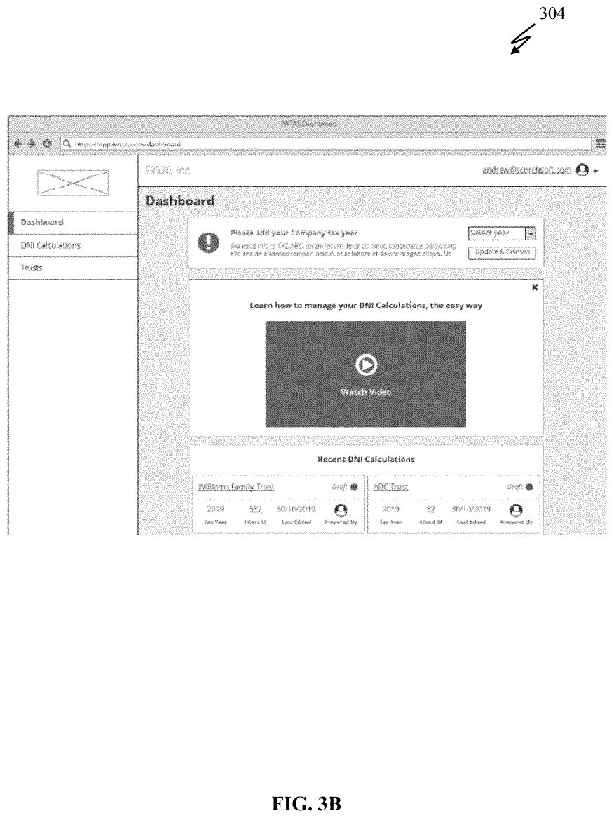

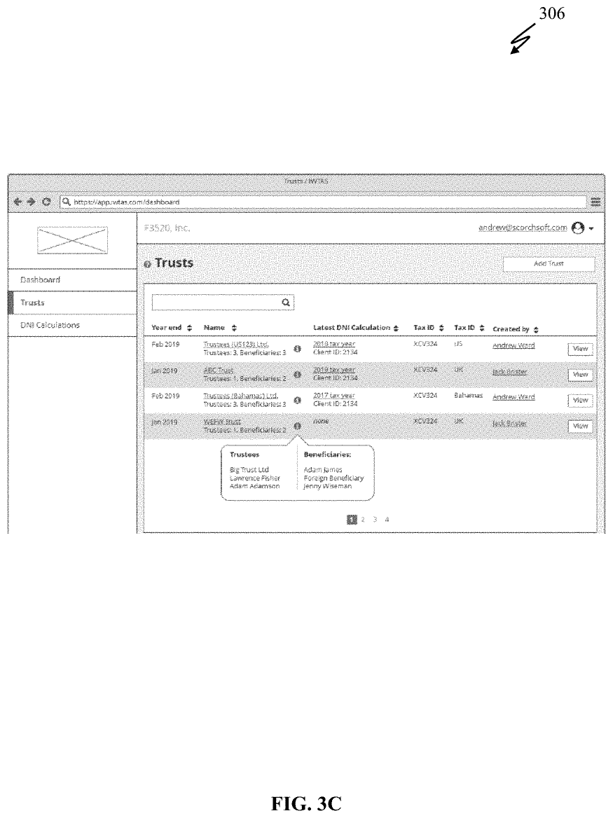

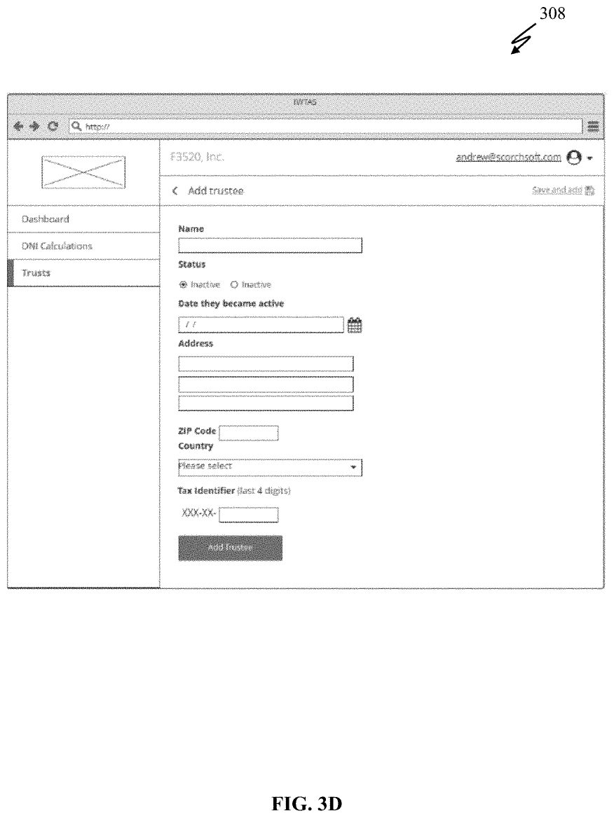

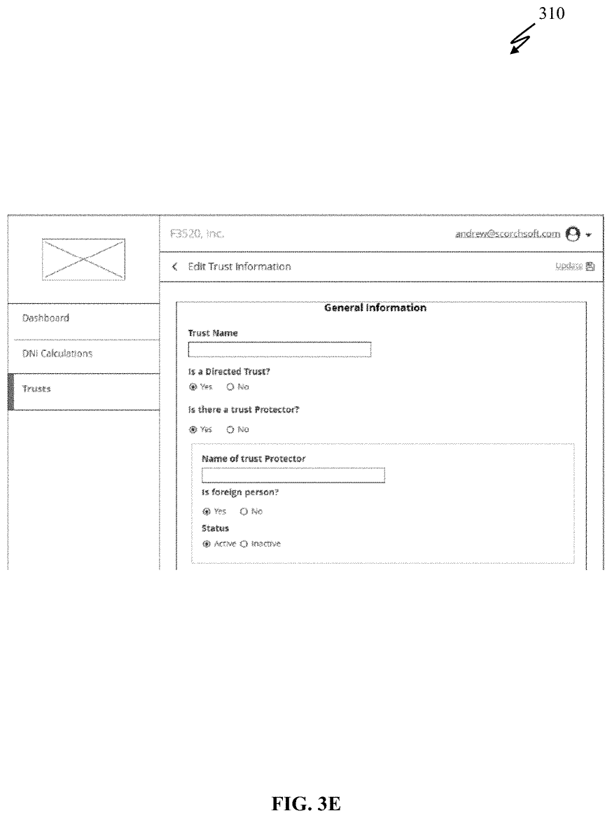

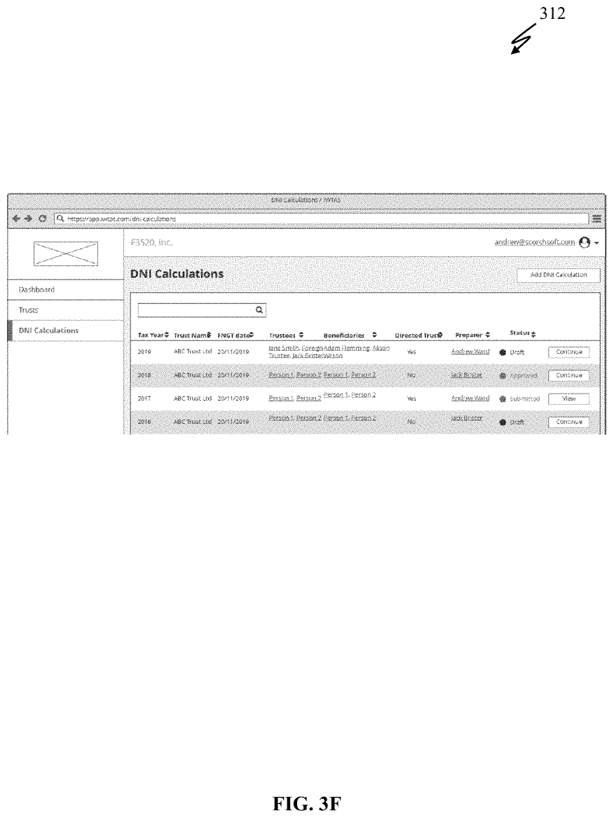

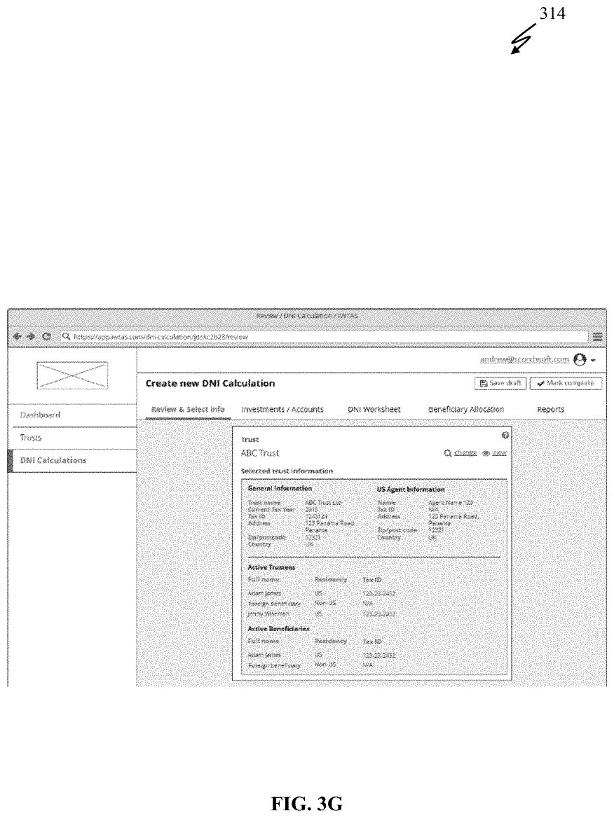

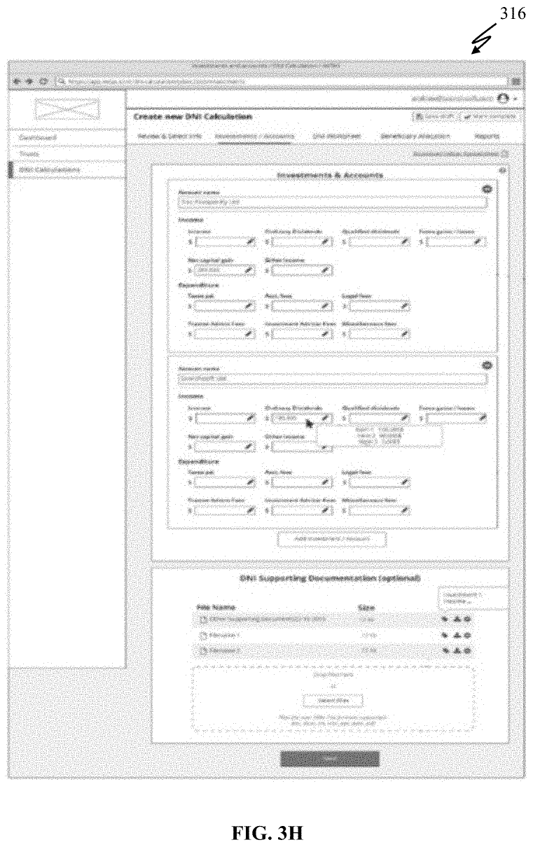

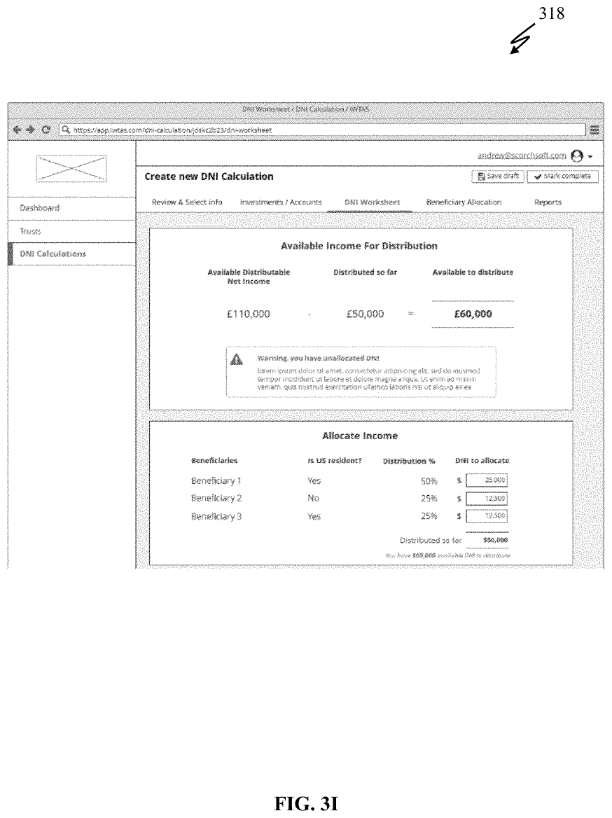

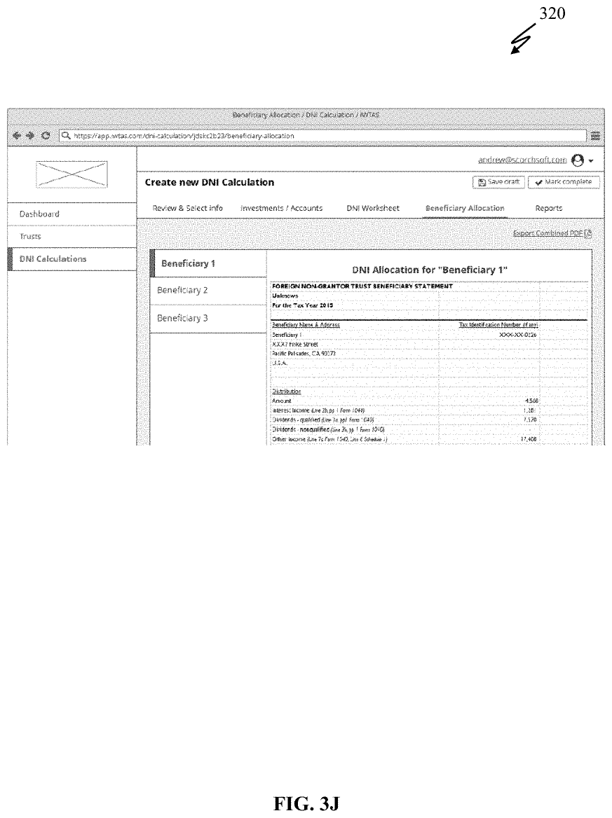

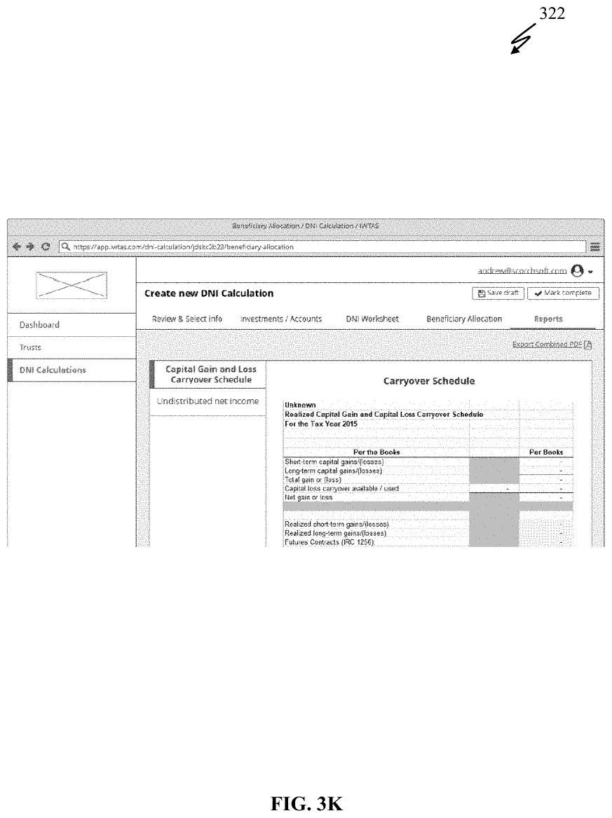

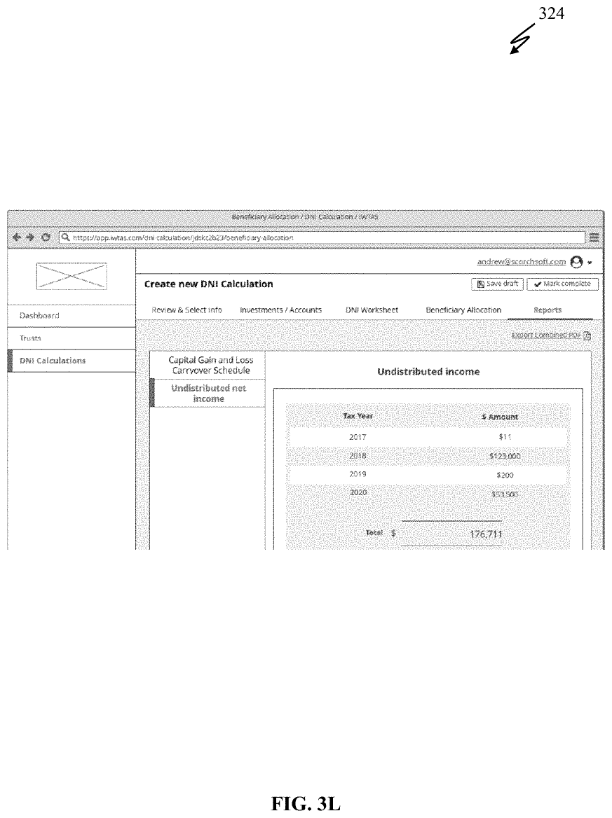

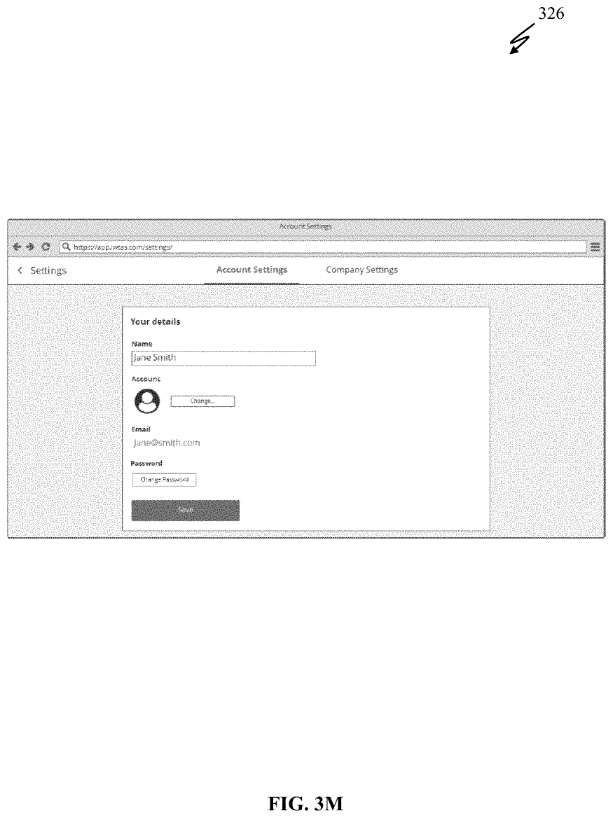

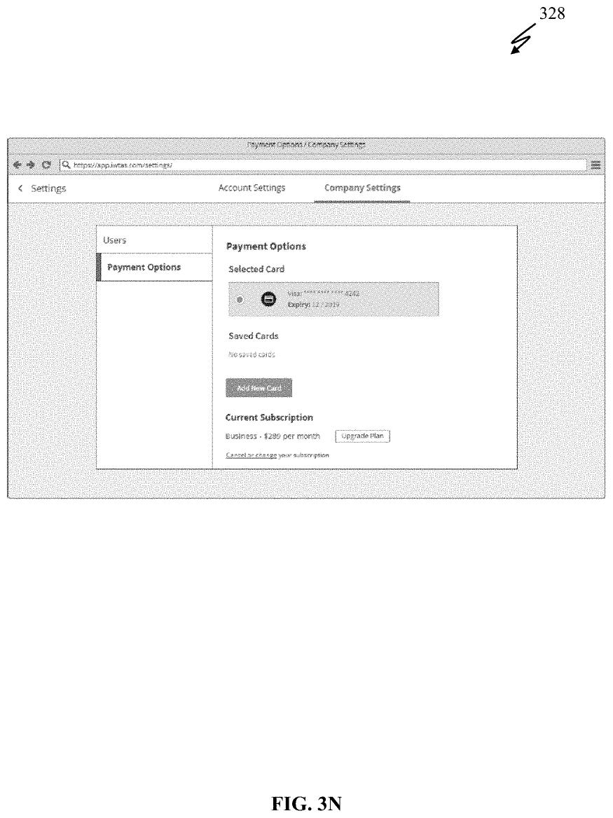

FIGS. 3A-3N illustrate a web application in accordance with an embodiment of the present disclosure. In one example embodiment, the web application may be operated by the front end block 102. It should be noted that the web application may facilitate the user with a graphical user interface (GUI). Further, embodiments may include a GUI that may either accept inputs from users or facilitates outputs to the users or may perform both the actions. In one case, a user can interact with the interface(s) using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the interface(s) may either be implemented as a Command Line Interface (CLI), a voice interface, or a web-based user-interface. The GUI may facilitate the user to input data related to investments, income, and expenditures related to the trust. In one embodiment, the GUI may send notifications in a user-friendly or interactive form to the user.

FIG. 3A illustrates a web application showing a login page 302 in accordance with an embodiment of the present disclosure. In one example embodiment, the login page 302 of the web application may facilitate the user to sign-up or sign-in to the web application. In one example embodiment, the login page 302 may display the benefits of using the web application. Further, the sign-up option may facilitate a new user to sign up for the web application. Further, the new user may enter information related to the user to sign up for the web application. In one example embodiment, the information related to the user may correspond to, but not limited to, the user's name, organization of the user, email address of the user, and a password. In another example embodiment, the login page 102 facilitates an already existing user to sign in to the web application. Further, the login page may request the user to input an email address already registered with the web application and a password corresponding to the email address. Further, based on a valid combination of the email address and password, entered by the user, the web application may redirect the user to a dashboard associated with the web application. In one example embodiment, after the login, the web application may redirect the user to a package selection page. Further, the package selection page may offer the user with a plurality of packages or subscriptions of the web application for determining of taxes of the trust. In one example embodiment, the web application may offer a monthly package or an annual package. Based on the selection of a package, the user may be redirected to a payment gateway, for completing the sign in.

FIG. 3B illustrates a web application showing a dashboard 304 in accordance with an embodiment of the present disclosure. After a successful sign in at the login page of the web application, the user may be directed to a dashboard of the web application. In one example embodiment, the dashboard may facilitate the user to view recent DNI calculations related to the user. Further, the dashboard may facilitate the user to view information related to one or more trusts corresponding to the user. Further, the information related to one or more trusts may include a tax year, a client ID, the last edited date for a particular trust, and user information of the user who prepared the information related to the particular trust. In one example embodiment, the dashboard may facilitate the user with tutorials related to DNI, for example, managing DNI calculations. It should be noted that the dashboard may prompt the user with a tax year selection field. The prompt related to the tax year may not disappear until the user specifies a tax year.

FIG. 3C illustrates a web application showing one or more trusts in a window 306 in accordance with an embodiment of the present disclosure. In one example embodiment, the window 306 may include the information related to all the trust corresponding to the user. Further, the information related to the trust may correspond, but not limited to, year, name of the trust, latest DNI calculation information, tax ID, associated country, created by field. Further, the window 306 may facilitate the user to view information related to each trust. In one example embodiment, the window 306 may display additional information like trustees and beneficiaries related to the trust.

FIG. 3D illustrates a web application a web application showing a view trust window 308 in accordance with an embodiment of the present disclosure. Based on the selection for viewing a particular trust, the user may be facilitated with a view trust window 308 corresponding to the selected trust. In one example embodiment, the view trust window 308 for the selected trust may include information, not limited to, general information, US agent information. notes corresponding to the trust, information related to beneficiaries of the selected trust, and information related to trustees of the selected trust. For example, the view trust window 308 may display trust name as ABC Trust Ltd., with current tax year as 2015, tax ID as 1234124, US agent name as Agent name 123, notes including information submitted by the user, information related to the beneficiary such as the full name of the beneficiary, tax ID related to the beneficiary, address of the beneficiary, status of the beneficiary. Further, the view trust window 308 may include the information related to the trustees such as the full name of the trustee, tax ID related to the trustee, address of the trustee, status of the trustee. In another example embodiment, the view trust window 308 may facilitate the user to add a beneficiary or add a trustee. In one additional embodiment, the view trust window 308 may facilitate the user to view change history related to the trusts. Further, the change history related to the trust may provide information related to change in trust, trustee, and beneficiaries.

FIG. 3E illustrates a web application a web application showing an edit trust window 310 in accordance with an embodiment of the present disclosure. In one example embodiment, the edit trust window 310 may enable the user to edit trust information such as, but not limited to, trust name, name of a trust protector, name of a trust investment advisor, and name of trust distribution advisor.

FIG. 3F illustrates a web application a web application showing a DNI calculation list window 312 in accordance with an embodiment of the present disclosure. In one example embodiment, the DNI calculation list window 312 may facilitate the user to view information related to historic DNI calculations. In one example embodiment, the information related to historic DNI calculations may include the tax year associated with the DNI calculation, trust name of the trust used for DNI calculation, trustees associated with the DNI calculation, beneficiaries associated with the DNI calculation, status whether the trust is a directed trust, name of the author for DNI calculation, and status of the DNI calculation. Further, DNI calculation list window 312 may facilitate the user to add a new DNI calculation.

FIG. 3G illustrates a web application a web application showing a step of new DNI calculations creation window 314 in accordance with an embodiment of the present disclosure. In one example embodiment, the DNI calculations creation window 314 may facilitate the user to create a new DNI calculation. The DNI calculations creation window 314 may facilitate the user to view investment/ accounts, DNI worksheets, beneficiary allocation, and reports for the new DNI calculation. Further, the DNI calculations creation window 314 may facilitate the user to view information related to a particular trust. For example, the information related to trust—ABC trust includes, general information related to ABC trust and US agent information related to ABC trust. Further, the information related ABC trust includes actives trustees and active beneficiaries. The DNI calculations creation window 314 may also facilitate the user with information related to the undistributed net income related to the particular trust. In one example embodiment, the DNI calculations creation window 314 may facilitate the user with information related to previous capital losses related to the particular trust. In another example embodiment, the DNI calculations creation window 314 may facilitate the user with information related to the year of termination related to the particular trust.

FIG. 3H illustrates a web application a web application showing a step of final investments copy in the new DNI calculations creation window 316 in accordance with an embodiment of the present disclosure. In one example embodiment the final investments copy in the new DNI calculations creation window 316 may facilitate the user to view and edit information related to investments and accounts related to the user. Further, information related to investments and accounts related to the user may include information related to capital gains. In another example embodiment, the final investments copy in the new DNI calculations creation window 316 may facilitate the user to view and edit information related to DNI supporting documentation related to the DNI calculation.

FIG. 3I illustrates a web application a web application showing another step of new DNI calculations creation window 318 in accordance with an embodiment of the present disclosure. In one example embodiment the final investments copy in the new DNI calculations creation window 318 may facilitate the user to view information related to available income for distribution related to the user. Further, information related to available income for distribution may comprise the available distributable net income and income distributed already and the income available for distribution. Further, the new DNI calculations creation window 318 may include information related to the one or more beneficiaries involved in the DNI calculation. In one example embodiment, the new DNI calculations creation window 318 may facilitate the user with detailed calculations related to the DNI calculations. For example, the detailed calculations may comprise income, capital gains, total gross income, and expenses related to the new DNI calculations. It should be noted that if the total combined capital gains and losses are negative, then the net capital gain number should be zero and not affect the DNI calculation for the current year. In addition, the negative combined (net) capital loss may be added to the total capital loss carried forward.

FIG. 3J illustrates a web application a web application showing a beneficiary allocation window 320 in accordance with an embodiment of the present disclosure. In one example embodiment, the beneficiary allocation window 320 may facilitate the user to view information related to the DNI allocation of a particular beneficiary. It should be noted that the beneficiary allocation window 320 may comprise information related to the particular beneficiary. For example, the allocation window 320 may comprise information such as, but not limited to, the name of the beneficiary, address of the beneficiary, information related to an associate trustee, short-term capital gains, and long term capital gains. Finally, the beneficiary allocation window 320 may facilitate the user to mark the allocation as complete and update the trust.

FIG. 3K illustrates a web application a web application showing a step of displaying a report 322 in accordance with an embodiment of the present disclosure. In one example embodiment, the report 322 may facilitate the user to view the capital gain and loss carryover schedule. Further, report 322 may facilitate the user with a carryover schedule. It should be noted that the carryover schedule may comprise data as per books, but not limited to, short-term capital gains, long-term capital gains, realized short-term capital gains, realized long-term capital gains, and net gains associated with the DNI calculation. In one example embodiment, the step of displaying the report 322 may facilitate the user to export the carryover schedule.

FIG. 3L illustrates a web application a web application showing a step of displaying another report 324 in accordance with an embodiment of the present disclosure. In one example embodiment, the report 324 may facilitate the user to view undistributed net income associated with the DNI calculation. In one example embodiment, the step of displaying the report 324 may facilitate the user to view undistributed income along with the corresponding year. In one example embodiment, the step of displaying the report 324 may facilitate the user to export the undistributed income.

FIG. 3M illustrates a web application a web application showing a window 326 for displaying account settings in accordance with an embodiment of the present disclosure. In one example embodiment, the window 326 may facilitate the user to view and change information related to the user. Further, the information related to the user may comprise, but is not limited to, user name, user display picture, user email address, and user password.

FIG. 3N illustrates a web application a web application showing a window 328 of displaying company settings in accordance with an embodiment of the present disclosure. In one example embodiment, the window 328 may facilitate the user to view and change information related to the users associated with a particular company. It should be noted that the window 328 may facilitate the user to add information related to a new user. Further, the window 328 may facilitate the user to add information related to the new user. Further, the information related to the new user may comprise, but is not limited to, user name, user display picture, user email address, and role of the new user in the company. Further, the window 328 may facilitate the user to change a subscription plan of the company. In one example embodiment, the window 328 may facilitate the user with payment options for completion of the change in the subscription.

While there is shown and described herein certain specific structures illustrating various embodiments of the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims. Those of skill in the art will appreciate, without limiting the scope of the present invention, the need for specialized processes in solving cross border tax issues and protecting offshore investment portfolios through efficient tax strategies. In particular, US law requires people who benefit from foreign trusts to include DNI Calculation Reports with their tax return. Given variable financial climate in light of jurisdictional tax laws new more robust processes are needed to assure legal compliance and minimization of tax liability to trusts and beneficiaries of trusts.

### LIST OF ELEMENTS

100 System
102 Front end block
104 Back end block
106 Third-party services block
108 Email block
110 Code block
112 Redux block
114 Application Programming Interface (API)
116 Database
118 Automation engine
120 Government tax API
122 Xero
124 Clear books
200 Method
202 Step
204 Step
206 Step
208 Step
210 Step
212 Step

302 Login page
304 Dashboard
306 Window
308 View trust window
310 Edit trust window
312 DNI calculation list window
314 DNI calculations creation window
316 DNI calculations creation window
318 DNI calculations creation window
320 Beneficiary allocation window
322 Report
324 Report
326 Window
328 Window

What is claimed is:

1. A method for determining a distributed net income (DNI) of a trust, the method comprises:
obtaining one or more information, wherein the one or more information includes at least general trust information, beneficiary information, and financial data information related to an income from trust's assets;
determining a net income of the trust's assets, a net realized rate of return, and a pre-defined year taxable income based on the obtained one or more information; and
determining the DNI of the trust, based on the net income of the trust's assets.

2. The method of claim 1, wherein the general trust information is the information associated with trustees and beneficiaries associated with the trust, the beneficiary information is the information associated with the beneficiaries of the trust, and financial data information is the information associated with income and expenses of the trustees and beneficiaries associated with the trust.

3. The method of claim 1, further comprises:
determining a DNI allocable to one or more beneficiaries;
displaying the DNI allocable to the one or more beneficiaries; and
alerting, the one or more beneficiaries, with the DNI allocable to the one or more beneficiaries.

4. The method of claim 1, further comprises determining the trust as a US-trust or a foreign trust, based on the general trust information.

5. The method of claim 4, comprises classifying the foreign trust into a foreign grantor trust or a foreign non-grantor trust.

6. The method of claim 1, further comprises computing a 65-day distribution rule to determine total amount of distributions made to the one or more beneficiaries of the trust, wherein the 65-day distribution rule is computed based on the determined DNI and trustee distribution patterns.

7. The method of claim 1, further comprises allocating the DNI to each of the one or more beneficiaries on a net basis or the amount of return of principal to be reported by each beneficiary.

8. The method of claim 1, further comprises determining tax return filing requirements for the US beneficiaries and trustee for the trust.

9. The method of claim 1, further comprises sending an alert and a list of filing requirements to the user.

10. The method of claim 1, further comprises determining life of the trust-based at least on an average rate of return, trustee distribution pattern of prior years' distributions, and current value of the trust's assets.

11. The method of claim 1, wherein the one or more information is obtained automatically, using third party services.

12. The method of claim 11, wherein the third party services include at least one of government tax application programming interfaces (APIs), Xero, and clear books.

13. The method of claim 1, further comprises estimating DNI based on historical DNI calculation data.

14. A system for determining a distributed net income (DNI) of a trust, the system comprising:
means for obtaining one or more information, wherein the one or more information includes at least a general trust information, a beneficiary information, and a financial data information related to an income from trust's assets;
means for determining a net income of the trust's assets, a net realized rate of return, and a pre-defined year taxable income based on the obtained one or more information;
means for determining the DNI of the trust, based on the net income of the trust's assets.

15. The system of claim 14, further comprising:
means for determining a DNI allocable to one or more beneficiaries;
means for displaying the DNI allocable to the one or more beneficiaries; and
means for alerting, the one or more beneficiaries, with the DNI allocable to the one or more beneficiaries.

16. The system of claim 14, further comprising means for determining the trust as a US-trust or a foreign trust, based on the general trust information.

17. The system of claim 16, comprising means for classifying the foreign trust into a foreign grantor trust or a foreign non-grantor trust.

18. The system of claim 14, further comprising means for allocating the DNI to each of the one or more beneficiaries on a net basis or the amount of return of principal to be reported by each beneficiary.

19. The system of claim 14, further comprising means for determining tax return filing requirements the US beneficiaries and trustee for the trust.

20. The system of claim 14, further comprising means for determining life of the trust-based at least on an average rate of return, trustee distribution pattern of prior years' distributions, and current value of the trust's assets.
